(19) United States
(12) Patent Application Publication
(10) Pub. No.: US 2025/0254375 A1
(43) Pub. Date: Aug. 7, 2025

(54) ARTIFICIAL INTELLIGENCE SYSTEM FOR MEDIA ITEM RECOMMENDATIONS

(71) Applicant: Google LLC, Mountain View, CA (US)

(72) Inventors: Nikhil Khani, Sunnyvale, CA (US); Maciej Kula, Mountain View, CA (US); Jarrod Kahn, Oakland, CA (US); Aniruddh Nath, San Francisco, CA (US); Shuo Yang, Santa Clara, CA (US); Yang Liu, Santa Clara, CA (US); Pendo Abbo, San Jose, CA (US); Li Wei, San Jose, CA (US); Shawn Andrews, Mountain View, CA (US); Zhe Zhao, San Francisco, CA (US); Lichan Hong, Lost Altos, CA (US); Ed Chi, Mountain View, CA (US)

(21) Appl. No.: 19/047,988

(22) Filed: Feb. 7, 2025

Related U.S. Application Data
(60) Provisional application No. 63/550,989, filed on Feb. 7, 2024.

(51) Int. Cl. H04N 21/25

(52) U.S. Cl. CPC H04N 21/251

(57) ABSTRACT

A method for generating AI media item recommendations includes generating a set of soft labels for a first training dataset using a teacher AI model. The first training dataset can reflect characteristics of first one or more media items accessible via a media platform. The set of soft labels can reflect predicted values of one or more metrics associated with the first one or more media items. The method further includes training a student AI model on the first training dataset using the set of soft labels generated by the teacher AI model and a set of observed labels associated with the first one or more media items. The student AI model may be trained to predict a score reflecting a relevance of a given media item to a user acting in a current user context of the media platform.

### CLAIM OF PRIORITY

The present application claims the benefit under 35 U.S.C. § 119 (e) of U.S. Provisional Patent Application No. 63,550,989, filed Feb. 7, 2024, and entitled, “ARTIFICIAL INTELLIGENCE SYSTEM FOR MEDIA ITEM RECOMMENDATIONS,” which is incorporated by reference herein.

### TECHNICAL FIELD

The instant specification generally relates to computing devices. More specifically, the instant specification relates to an artificial intelligence system for media item recommendations.

### BACKGROUND

Some computing platforms provide media items to client devices connected to the platform via a network. Such media items can be videos, images, audio, text, or other media items. The media items often include media uploaded to the platform by users of the platform.

### SUMMARY

One aspect of the present disclosure includes a method. The method includes generating a set of soft labels for a first training dataset. The method may use a teacher artificial intelligence (AI) model to generate the set of soft labels. The first training dataset can reflect characteristics of first one or more media items accessible via a media platform. The set of soft labels can reflect predicted values of one or more metrics associated with the first one or more media items. The method further includes training a student AI model on the first training dataset using the set of soft labels generated by the teacher AI model and a set of observed labels associated with the first one or more media items. The student AI model may be trained to predict a score reflecting a relevance of a given media item to a user acting in a current user context of the media platform.

Another aspect of the present disclosure includes a method for generating media item recommendations for a user. The method includes, responsive to a user of a media platform accessing a selected media item of the media platform on a client device, identifying a set of candidate media items of the media platform. The method includes determining, using a trained first AI model, one or more scores reflecting a respective relevance of each media item of the set of candidate media items to the user. The trained first AI model may have been trained on a training dataset. The training dataset may include one or more characteristics of one or more media items accessible via the media platform, a set of soft labels produced by a second AI model, and a set of observed labels. The set of soft labels may reflect predicted values of one or more metrics associated with the one or more media items, and the set of observed labels can reflect observed values of the one or more metrics associated with the one or more media items. The method includes ordering at least a subset of the set of candidate media items based on the one or more scores. The method includes causing at least a portion of the subset of the set of candidate media items to be provided to the client device for presentation as the media item recommendations for the user accessing the selected media item.

Another aspect of the present disclosure includes a system. The system includes a processing device and a memory coupled with the processing device. The memory includes instructions that when executed by the processing device, perform operations. The operations include, responsive to a user of a media platform accessing a selected media item of the media platform on a client device, identifying a set of candidate media items of the media platform. The operations include determining, using a trained first AI model, one or more scores reflecting a respective relevance of each media item of the set of candidate media items to the user. The trained first AI model may have been trained on a training dataset. The training dataset may include one or more characteristics of one or more media items accessible via the media platform, a set of soft labels produced by a second AI model, and a set of observed labels. The set of soft labels may reflect predicted values of one or more metrics associated with the one or more media items, and the set of observed labels can reflect observed values of the one or more metrics associated with the one or more media items. The operations include ordering at least a subset of the set of candidate media items based on the one or more scores. The operations include causing at least a portion of the subset of the set of candidate media items to be provided to the client device for presentation as the media item recommendations for the user accessing the selected media item.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 schematically illustrates an example system for an artificial intelligence (AI) system for media item recommendations, in which selected aspects of the present disclosure may be implemented, in accordance with various embodiments.

FIG. 2 schematically illustrates an example artificial intelligence (AI) training subsystem, in accordance with implementations of the present disclosure

FIG. 3 schematically illustrates an example AI inference subsystem, in accordance with implementations of the present disclosure

FIG. 4 depicts a flowchart illustrating an example method for training a teacher AI model and a student AI model, in accordance with various embodiments.

FIG. 5 depicts a flowchart illustrating an example method for generating media item recommendations for a user, in accordance with various embodiments.

FIG. 6 schematically illustrates an example AI model, in accordance with implementations of the present disclosure.

FIG. 7 depicts a block diagram of an example computer device for an AI system for media item recommendations, in accordance with some implementations of the present disclosure.

### DETAILED DESCRIPTION

Aspects of the present disclosure generally relate to an artificial intelligence (AI) system for media item recommendations. Media platforms can provide media items (content) for users of the platform to access using the user's respective client devices. Such media platforms can include video platforms (e.g., video-on-demand, video livestreams, etc.), audio platforms (e.g., for consuming music, audiobooks, podcasts, etc.), image platforms (e.g., for sharing images), and other types of media platforms. A media platform can recommend content on the platform for users to access. Recommending content that is relevant to a user generally enhances the user's experience with the platform.

However, recommending relevant content can be challenging because the media platform may have thousands or even millions of media items, and only a small portion of the content may be relevant to a certain user. Furthermore, users often have widely varying interests, and determining which content aligns with those interests can be difficult. Some media platforms use AI to determine content to recommend to users. In such platforms, recommendation quality is often a function of the size of the AI model used to determine recommended content. However, large AI models often require long processing times, which can delay providing content recommendations to users' client devices, thus adversely affecting the user's experience and leading to the user's abandoning the platform. Therefore, an effective recommendation system should balance recommendation quality and recommendation serving latency.

Aspects and implementations of the present disclosure address the above-noted and other deficiencies by implementing a knowledge distillation-based AI system to recommend media items to users of a media platform. Such an AI system may include a teacher AI model and one or more student AI models. The AI system may train the teacher AI model on a set of training data based on observed metrics for media items of the media platform. The AI system may then cause the teacher AI model to generate soft labels for media items of the media platform. A soft label may include a logit, which may include a raw, unscaled output of the final layer of a neural network of the AI model before the output is provided to a softmax function. The soft labels and observed metrics are then used to train the one or more student AI models, which are trained to minimize the joint loss over the soft labels and observed metrics. The joint loss may include a value calculated by a joint loss function, which may combine multiple loss terms to train the student AI model effectively. By using this training process instead of training the student models directly, knowledge learned by the teacher AI model is efficiently distilled into the student AI models during training.

Aspects and implementations of the disclosure may generate, using the teacher AI model, a set of soft labels for a first training dataset. The first training dataset can reflect characteristics of a first set of media items accessible via the media platform. Characteristics of the first set of media items may include, for example, title, genre, author/creator, subject, duration, content keywords, content description, user-generated tags, language, channel association, playlist association, etc. The set of soft labels are predicted by the teacher AI model to estimate values of one or more metrics associated with the first set of media items and may not be 100 percent accurate (e.g., accuracy may depend on performance quality of the teacher AI model). The system may train a student AI model on the first training dataset using the set of soft labels generated by the teacher AI model and a set of observed labels associated with the first set of media items. The set of observed labels can be extracted from historical data associated with the first set of media items and are ground truth (e.g., have objectively high accuracy). The student AI model may be trained to predict a score reflecting a relevance of a given media item to a user accessing a selected media item of the media platform.

Responsive to a user of the media platform accessing a selected media item of the media platform on a client device, the system may identify a set of candidate media items of the media platform. The system may determine, using a trained first artificial intelligence (AI) model (e.g., one of the one or more student AI models), a set of scores reflecting a respective relevance of each media item of the set of candidate media items to the user in the current context (e.g., the selected media item currently accessed by the user, one or more media items recently accessed by the user, a type of a user device, current connection parameters). The trained first AI model may be trained on a training dataset that includes (1) a set of characteristics of a set of media items accessible via the media platform, (2) a set of soft labels produced by a second AI model (e.g., the teacher AI model) that reflecting predicted values of one or more metrics associated with the set of media items, and (3) a set of observed labels that reflect observed values of the one or more metrics associated with the plurality of media items. The system may order at least a subset of the set of candidate media items based on the set of scores. The system may cause at least a portion (e.g., higher ranked candidate media items) of the subset of the set of candidate media items to be provided to the user's client device for presentation as the media item recommendations for the user accessing the selected media item.

Some benefits of the present disclosure may provide a technical effect caused by or resulting from a technical solution to a technical problem. For example, one technical problem may relate to using large AI models to generate content rankings, which may cause a delay in providing data based on the rankings to client devices. One of the technical solutions to the technical problem may include using a knowledge distillation student AI model instead of a large AI model to generate the rankings. As a consequence, by using the student AI model, which is a lightweight model relative to a larger AI model, a computing device (e.g., a server of a media platform) implementing the student model uses fewer computing resources such as processing power, processing time, memory, network usage, etc. Additionally, the delay in generating the rankings and providing data based on the rankings to users' client devices is reduced. Furthermore, by using knowledge distillation AI models, selection biases of the content can also be reduced or eliminated.

In some implementations, a computing device may include a physical computing device or may include a virtualized component, such as a virtual machine (VM) or a container. A computing device may include an instance of a computing device. An instance of a computing device may include a spun-up instance that may not be specific to any computing device. In some implementations, a VM may include a system virtual machine, which may include a VM that emulates an entire physical computing device. A VM can include a process virtual machine, which may include a VM that emulates an application or some other software. A container may include a computing environment that logically surrounds one or more software applications independently of other applications executing in the cloud computing environment.

In implementations of the disclosure, a “user” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether the media platform collects user information (e.g., information about a user's social network, social actions or activities, profession, a user's preferences, or a user's current location), or to control whether and/or how to receive content from the media platform that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the media platform.

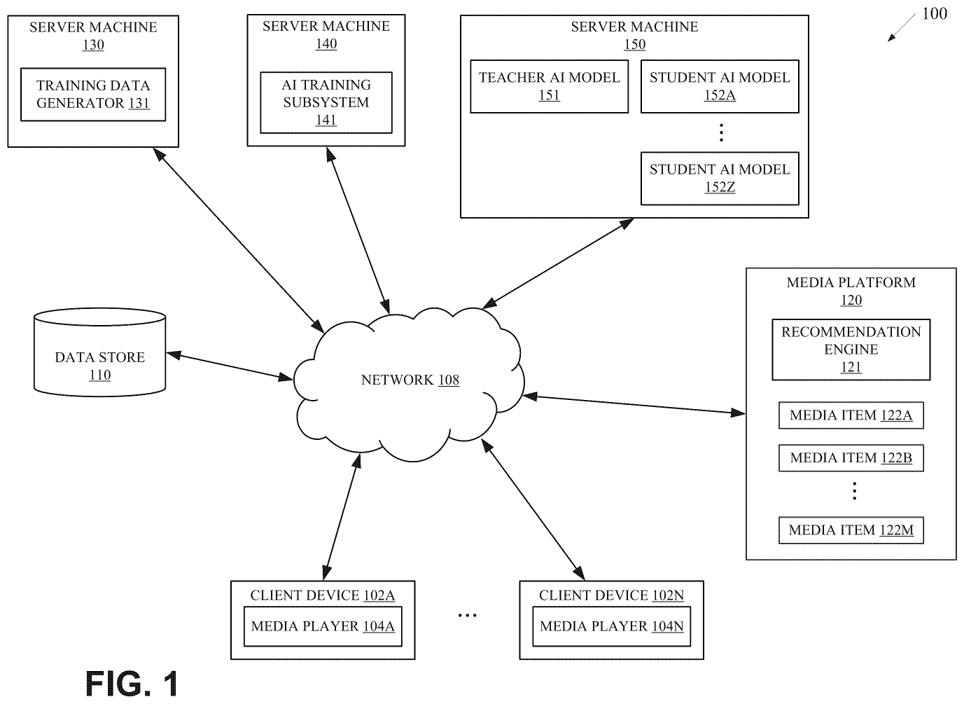

FIG. 1 illustrates an example system architecture 100, in accordance with implementations of the present disclosure. The system architecture 100 (also referred to as a “system” herein) includes one or more client devices 102A-102N, a data store 110, a media platform 120, and/or one or more server machines 130, 140, 150 each connected to a network 108.

The one or more client devices 102A-102N can each include computing devices such as personal computers (PCs), laptops, mobile phones, smart phones, tablet computers, netbook computers, network-connected televisions, etc. In some implementations, the client devices 102A-102N can also be referred to as “user devices.” In some implementations, each client device 102A-102N can include a media player 104A-104N. In some implementations, the media players 104A-104N can be applications that allow users, such as content creators, viewers, etc. to play back, view, or upload content, such as images, video items, web pages, documents, audio items, etc. For example, the media players 104A-104N can be a web browser that can access, retrieve, present, or navigate content (e.g., web pages such as Hyper Text Markup Language (HTML) pages, digital media items, etc.) served by a web server. A media player 104A-104N can render, display, or present the content (e.g., a web page, a media viewer) to a user. In some implementations, a media player 104A-104N can provide a user interface for presenting the media items and/or enabling user interaction with the media player 104A-104N. A media player 104A-104N can also include an embedded media player (e.g., a Flash® player or an HTML5 player) that is embedded in a web page (e.g., a web page that can provide information about a product sold by an online merchant). In another example, the media players 104A-104N may be standalone applications (e.g., a mobile application, or native application) that allows users to playback digital media items (e.g., digital video items, digital images, electronic books, etc.). According to some aspects of the present disclosure, the media players 104A-104N may be a media platform 120 application for users to record, edit, and/or upload content for sharing on the media platform 120. As such, the media players 104A-104N can be provided to the client devices 102A-102N by the media platform 120. For example, the media players 104A-104N can be embedded media players that are embedded in web pages provided by the media platform 120. In another example, the media players 104A-104N can be applications that are downloaded from media platform 120.

In some implementations, the network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, the data store 110 is a persistent storage that is capable of storing data as well as data structures to tag, organize, and index the data. The data store 110 can be hosted by one or more storage devices, such as main memory, magnetic or optical storage-based disks, tapes or hard drives, NAS, SAN, and so forth. In some implementations, the data store 110 may be a network-attached file server, while in other implementations, the data store 110 may be some other type of persistent storage such as an object-oriented database, a relational database, and so forth, that may be hosted by the media platform 120 or one or more different machines (e.g., one or more of the server machines 130, 140, 150 or one or more of the client device 102A-102N) coupled to the media platform 120 via network 108.

In some implementations, the media platform 120 and the one or more server machines 130, 140, 150, may be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that can be used to provide a user with access to media items of the media platform 120 or provide the media items to the user. For example, the media platform 120 can allow a user of a client device 102A-N to access, upload, search for, approve of (“like”), disapprove of (“dislike”), share with other users (“share”), or comment on media items. The media platform 120 can also include a website (e.g., a webpage) or application back-end software that can be used to provide a user with access to the media items.

The media platform 120 can include a recommendation engine 121. In one implementation, the recommendation engine 121 may provide data reflecting recommendations of media items of the media platform 120 to a client device 102A-N, which may allow a client device 102A-N to access one or more of the recommended media items. The recommendation engine 121 may use one or more AI models to score one or more media items of the media platform 120 so the recommendation engine 121 can order the recommended media items 122 based on their respective scores, as discussed herein.

The media platform 120 can include one or more media items 122A-M. Examples of a media item 122A-M can include, and are not limited to, digital videos, digital movies, digital photos, digital music, audio content, melodies, website content, social media updates, electronic books (ebooks), electronic magazines, digital newspapers, digital audio books, electronic journals, web blogs, real simple syndication (RSS) feeds, electronic comic books, software applications, etc. In some implementations, the media item 122A-M can be a live-stream media item. In some implementations, a media item 122A-M is also referred to as content or a content item.

For brevity and simplicity, rather than limitation, a video item, audio item, or gaming item are used as an example of a media item 122A-M throughout this document. As used herein, “media,” media item,” “online media item,” “digital media,” “digital media item,” “content,” and “content item” can include an electronic file that can be executed or loaded using software, firmware or hardware configured to present the digital media item to an entity. In one implementation, media platform 120 can store the media items 122A-M using the data store 110. In another implementation, media platform 120 can store video items or fingerprints as electronic files in one or more formats using data store 110.

In some implementations, media items 122A-M are video items. A video item is a set of sequential image frames representing a scene in motion. For example, a series of sequential image frames can be captured continuously or later reconstructed to produce animation. Video items can be presented in various formats including, but not limited to, analog, digital, two-dimensional and three-dimensional video. Further, video items can include movies, video clips or any set of animated images to be displayed in sequence. In addition, a video item (or media item) can be stored as a video file that includes a video component and an audio component. The video component can refer to video data in a video coding format or image coding format (e.g., H.264 (MPEG-4 AVC), H.264 MPEG-4 Part 2, Graphic Interchange Format (GIF), WebP, etc.). The audio component can refer to audio data in an audio coding format (e.g., advanced audio coding (AAC), MP3, etc.). It can be noted GIF can be saved as an image file (e.g., .gif file) or saved as a series of images into an animated GIF (e.g., GIF89a format). It can be noted that H.264 can be a video coding format that is a block-oriented motion-compensation-based video compression standard for recording, compression, or distribution of video content, for example.

In some implementations, a media item 122A-M can be streamed, such as in a live-stream, to one or more of the client devices 102A-102N. It is be noted that “streamed” or “streaming” refers to a transmission or broadcast of content, such as a media item 122A-M, where the received portions of the media item 122A-M can be played back by a receiving device immediately upon receipt (within technological limitations) or while other portions of the media item 122A-M are being delivered, and without the entire media item 122A-M having been received by the receiving device. “Stream” can refer to content, such as a media item 122A-M, that is streamed or streaming. A live-stream media item 122A-M can refer to a live broadcast or transmission of a live event, where the media item 122A-M is concurrently transmitted (e.g., from media capturing device 115A-115Z), at least in part, as the event occurs to a receiving device, and where the media item 122A-M is not available in its entirety.

In some implementations, a user can access content on the media platform 120 through a user account. The user can access (e.g., log in to) the user account by providing user account information (e.g., username and password) via an application on a client device 102A-N (e.g., media player 104A-104N). In some implementations, the user account can be associated with a single user. In other implementations, the user account can be a shared account (e.g., family account shared by multiple users) (also referred to as “shared user account” herein). The shared account can have multiple user profiles, each associated with a different user. The multiple users can login to the shared account using the same account information or different account information. In some implementations, the multiple users of the shared account can be differentiated based on the different user profiles of the shared account.

In some implementations, the media platform 120 can use a content distribution network (CDN) (not shown) to stream the media items 122A-M to one or more client devices 102A-102N for consumption by users. A CDN includes a geographically distributed network of servers that work together to provide fast delivery of content. The network of the servers can be geographically distributed to provide high availability and high performance by distributing content or services based, in some instances, on proximity to client devices 102A-102N. The closer a CDN server is to a client device 102A-102N, the faster the content can be delivered to the client device 102A-102N.

In some implementations, the training data generator 131 (residing at server machine 130) can generate training data to be used to train one or more AI models. In some implementations, the training data generator 131 can generate the training data based on one or more metrics of one or more media items 122A-M. A metric of a media item 122A-M can include specific data related to a particular media item 122A-M. A metric may include an engagement metric or a satisfaction metric.

An engagement metric may include a measurement indicating how a user of a client device 102A-N interacts with a media item 122A-M beyond accessing the media item 122A-M. For example, for a video media item 122A-M, accessing the media item 122A-M may include watching the video. For an image media item 122A-M, accessing the media item 122A-M may include viewing the image. For an audio media item 122A-M, accessing the media item may include playing the audio. One example of an engagement metric can include a click-through rate (CTR) of a media item 122A-M. A CTR may include the ratio of the number of times users access a media item 122A-M to the number of times the opportunity to access the media item 122A-M is presented to users. Another example of an engagement metric can include an access time of a media item 122A-M. Access time may include the time a user spends accessing the media item 122A-M. For example, where the media item 122A-M is a video, the access time may include the time users spend watching the video. Where the media item 122A-M is an image, access time may include the time users spend viewing the image. Where the media item is audio, access time may include the time users spend listening to the audio.

The media platform 120 may include functionality that allows users to provide feedback associated with a media item 122A-M. The feedback may indicate opinions and preferences of users that have accessed the media item 122A-M. For such media platforms 120, an example of an engagement metric can include a number of positive feedback items received for a media item 122A-M. A positive feedback item may include data indicating that user had a positive experience associated with the media item 122A-M. Examples of positive feedback items can include a user interacting with a “like” button or a “thumbs-up” button, a user providing a positive comment associated with the media item 122A-M, following or subscribing to the author/creator of the media item 122A-M, or saving the media item 122A-M to a certain list of media items (e.g., a “favorites” list). Another example of an engagement metric may include a number of negative feedback items received for a media item 122A-M. Examples of negative feedback items can include a user interacting with a “dislike” button or a “thumbs-down” button, a user providing a negative comment associated with the media item 122A-M, or unfollowing or unsubscribing to the author/creator of the media item 122A-M.

Another example of an engagement metric can include a dismissal rate of a media item 122A-M. The dismissal rate may include the ratio of the number of users that do not access the media item up to a predetermined point in the media item 122A-M to the number of users that access the media item 122A-M. The predetermined point may include the end of the media item 122A-M, the midpoint of the media item 122A-M, or some other point in the media item 122A-M. Another example of an engagement metric includes a number of sharing actions with respect to a media item 122A-M. A sharing action may include an action a user performs to inform other people about the media item 122A-M. A sharing action may include a user emailing or texting a link to the media item 122A-M to another person, posting a link to the media item 122A-M on a social media service, or the like.

In some embodiments, a subset of engagement metrics includes satisfaction metrics. A satisfaction metric may include a measurement indicating how satisfied a user of a client device 102A-N is with a media item 122A-M. Examples of satisfaction metrics may include a number of positive feedback items received for a media item 122A-M, a number of negative feedback items received for a media item 122A-M, or a dismissal rate of a media item 122A-M, as discussed above.

In some implementations, the server machine 140 may include a AI training subsystem 141. The AI training subsystem 141 can train one or more AI models using the training data from training data generator 131. In some implementations, an AI model can refer to the model artifact that is created by the AI training subsystem 141 using the training data that includes training inputs and corresponding ground truths (correct answers for respective training inputs). The AI training subsystem 141 can find patterns in the training data that map the training input to the ground truth (the answer to be predicted) and provide the AI model that captures these patterns.

The server machine 150, in some implementations, can include a knowledge distillation teacher AI model 151 (referred to herein as a “teacher AI model,” a “teacher model,” or a “teacher”) and one or more knowledge distillation student AI models 152A-Z (referred to herein as a “student AI model,” “student model,” or a “student”). The teacher AI model 151 and the one or more student AI models 152A-Z may form part of a knowledge distillation framework. As discussed above, the teacher AI model 151 may generate a set of soft labels for a training dataset, and the student models 152A-Z may be trained on the training dataset using the soft labels and a set of observed labels extracted from historical data associated with media items in the training dataset. The student AI models 152A-Z may be trained to predict scores reflecting the relevance of media items 122A-M to users accessing selected media items 122A-M of the media platform 120. The scores can be provided to the recommendation engine 121 so the recommendation engine 121 can order recommended media items 122A-M based on their respective scores.

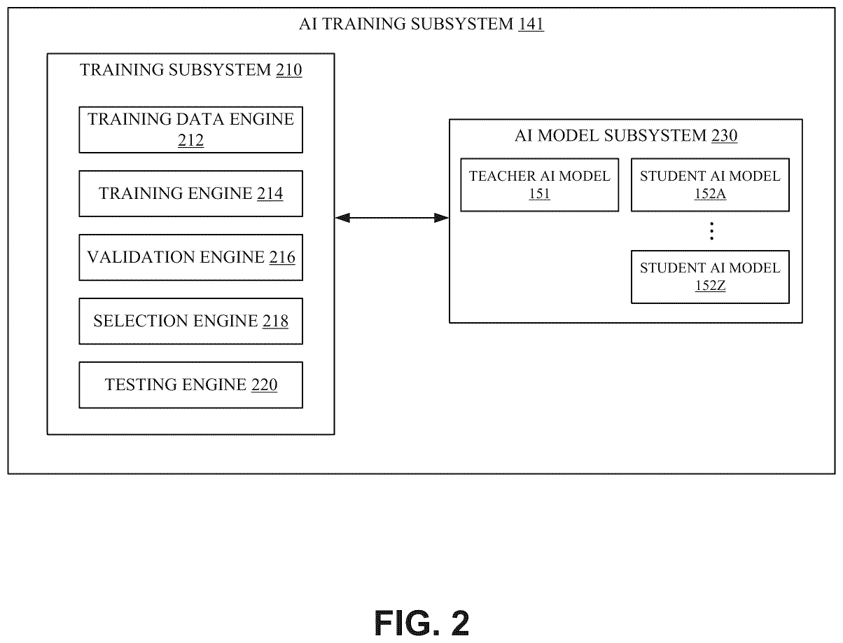

FIG. 2 schematically illustrates an example AI training subsystem 141, in accordance with implementations of the present disclosure. As illustrated in FIG. 2, the AI training subsystem 141 may include a training subsystem 210, which may include a training data engine 212, a training engine 214, a validation engine 216, a selection engine 218, or a testing engine 220. The AI training subsystem 141 may include an AI model subsystem 230. The AI model subsystem 230 may include one or more AI models 151, 152A-Z.

In one implementation, the AI model 151, 152A-Z includes one or more of artificial neural networks (ANNs), decision trees, random forests, support vector machines (SVMs), clustering-based models, Bayesian networks, or other types of machine learning models. ANNs generally include a feature representation component with a classifier or regression layers that map features to a target output space. The ANN can include multiple nodes (“neurons”) arranged in one or more layers, and a neuron can be connected to one or more neurons via one or more edges (“synapses”). The synapses can perpetuate a signal from one neuron to another, and a weight, bias, or other configuration of a neuron or synapse can adjust a value of the signal. Training the ANN may include adjusting the weights or other features of the ANN based on an output produced by the ANN during training.

An ANN may include, for example, a convolutional neural network (CNN), recurrent neural network (RNN), or a deep neural network. A CNN, a specific type of ANN, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). A deep network may include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that can be used is a long short term memory (LSTM) neural network.

ANNs can learn in a supervised (e.g., classification) or unsupervised (e.g., pattern analysis) manner. Some ANNs (e.g., such as deep neural networks) may include a hierarchy of layers, where the different layers learn different levels of representations that correspond to different levels of abstraction. In deep learning, each level learns to transform its input data into a slightly more abstract and composite representation.

In some implementations, an AI model 151, 152A-Z includes one or more pre-trained models, or fine-tuned models. In a non-limiting example, in some implementations, the goal of the “fine-tuning” is accomplished with a second, or third, or any number of additional models. For example, the outputs of the pre-trained model can be input into a second AI model 151, 152A-Z that has been trained in a similar manner as the “fine-tuned” portion of training above. In such a way, two more AI models 151, 152A-Z can accomplish work similar to one model that has been pre-trained, and then fine-tuned.

In some implementations, different AI models 151, 152A-Z of the one or more AI models 151, 152A-Z are different types of AI models 151, 152A-Z. Multiple AI models 151, 152A-Z of the one or more AI models 151, 152A-Z can form an ensemble.

In some implementations, the teacher AI model 151 and the one or more student AI models 152A-Z share a common architecture comprising multiple neural network layers. A size of a layer of the teacher AI model 151 may be a multiple of a size of a corresponding layer of a student AI model 152A-Z. In one or more implementations, a number of shared layers comprised by the teacher AI model 151 is a multiple of a number of shared layers comprised by a student AI model 152A-Z. In some implementations, two or more student AI models 152A-Z are co-trained with the teacher AI model 151 to facilitate a selection of a best performing student AI model 152A-Z for inference.

In one implementation, the training subsystem 210 manages the training and testing of the one or more AI models 151, 152A-Z. The training data engine 212 can generate or obtain training data (e.g., a set of training inputs and a set of target outputs) to train an AI model 151, 152A-Z. The training data engine 212 may obtain training data from the training data generator 131, or the training data engine 212 may obtain metrics or other data for media items 122A-M from the training data generator 131 and may generate the training data from the received metrics or other data. In an illustrative example, the training data engine 212 can initialize a training set T to null. The training data engine 212 can add the training data to the training set T and can determine whether training set T is sufficient for training the AI model 151, 152A-Z. The training set T can be sufficient for training the AI model 151, 152A-Z if the training set T includes a threshold amount of training data, in some implementations. In response to determining that the training set T is not sufficient for training, the training data engine 212 can identify additional training data and add it to the training set T. In response to determining that the training set T is sufficient for training, the training data engine 212 can provide the training set T to the training engine 214.

A piece of training data may include a training input and a training output. For the teacher AI model 151, a piece of training data may include a training input that includes characteristics of a media item 122 (e.g., title, genre, author/creator, subject, etc. as discussed above), and the corresponding target output may include a soft label for the media item 122. For the one or more student AI models 152A-Z, a piece of training data may include a training input that includes characteristics of a media item 122, and the corresponding target output may include a soft label for the media item 122 that was generated by the teacher AI model 151. The target output for the student model(s) 151A-Z may further include observed labels, which may include the actual metrics of the media item 122 of the training input.

The training engine 214 can train the AI model 151, 152A-Z using the training data (e.g., training set T). The AI model 151, 152A-Z can refer to the model artifact that is created by the training engine 214 using the training data, where such training data can include training inputs and, in some implementations, corresponding target outputs (e.g., correct answers for respective training inputs). The training engine 214 can input the training data into the AI model 151, 152A-Z so that the AI model 151, 152A-Z can find patterns in the training data and configure itself based on those patterns.

Where the AI model 151, 152A-Z uses supervised learning, the training engine 214 can assist the AI model 151, 152A-Z in determining whether the AI model 151, 152A-Z maps the training input to the target output (the answer to be predicted). Where the AI model 151, 152A-Z uses unsupervised learning, the training engine 214 can input the training data into the AI model 151, 152A-Z. The AI model 151, 152A-Z can configure itself based on the input training data, but since the training data may not include a target output, the training engine 214 may not assist the AI model 151, 152A-Z in determining whether the AI model 151, 152A-Z provided a correct output during the training process.

The validation engine 216 may be capable of validating a trained AI model 151, 152A-Z using a corresponding set of features of a validation set from the training data engine 212. The validation engine 216 can determine an accuracy of each of the trained AI models 151, 152A-Z based on the corresponding sets of features of the validation set. Where the training data may not include a target output, validating a trained AI model 151, 152A-Z may include obtaining an output from the AI model 151, 152A-Z and providing the output to another entity for evaluation. The other entity may include another AI model configured to evaluate the output of the AI model that is undergoing training. The other entity may include a human. The validation engine 216 can discard a trained AI model 151, 152A-Z that has an accuracy that does not meet a threshold accuracy or that otherwise fails evaluation. In some implementations, the selection engine 218 is capable of selecting a trained AI model 151, 152A-Z that has an accuracy that meets a threshold accuracy. In some implementations, the selection engine 218 is capable of selecting the trained AI model 151, 152A-Z that has the highest accuracy of multiple trained AI models 151, 152A-Z. In some implementations, the selection engine 218 obtains input from another AI model or a human and can select a trained AI model 151, 152A-Z based on the input.

The testing engine 220 may be capable of testing a trained AI model 151, 152A-Z using a corresponding set of features of a testing set from the training data engine 212. For example, a first trained AI model 151, 152A-Z that was trained using a first set of features of the training set may be tested using the first set of features of the testing set. The testing engine 220 can determine a trained AI model 151, 152A-Z that has the highest accuracy or other evaluation of all of the trained AI models 151, 152A-Z based on the testing sets.

In some implementations, the AI model subsystem 230 selects an AI model 151, 152A-Z from the one or more AI models 151, 152A-Z. Selecting an AI model 151, 152A-Z may include selecting the AI model 151, 152A-Z for training or for use. For example, the training subsystem 210 can provide data to the AI model subsystem 230 indicating which AI model 151, 152A-Z is to be trained. The AI model subsystem 230 can obtain data from a component of the system architecture 100 (e.g., the recommendation engine 121 or the training data generator 131 indicating which AI model 151, 152A-Z to use to generate output.

The AI training subsystem 141 may cause the trained teacher AI model to generate soft labels for a first training dataset reflecting characteristics of a set of media items 122A-M of the media platform 120. The first training dataset may be different than the training dataset used to train the teacher AI model 151 as discussed above. The AI training subsystem 141 may then train one or more of the student AI models 152A-Z on the same first training dataset using the set of soft labels and a set of observed labels associated with the first training dataset. The trained student AI model 152A-Z may then be ready to generate media item recommendations for users of the media platform 120. The training of the student AI model(s) 152A-Z may be repeated periodically with training datasets that reflect characteristics of media items 122A-M recently uploaded to the media platform 120. In this manner, the student can be updated on new data in order to provide quality recommendations that may include new media items 122A-M.

In some implementations, the AI training subsystem 141 may train the teacher AI model 151 on a training dataset that reflects characteristics of a set of media items 122A-M of the media platform 120. The teacher AI model 151 may be trained to generate soft labels for data input into a student AI model 1512A-Z. A soft label may reflect predicted values of one or more metrics associated with the set of media items 122A-M. A soft label may include a logit. A logit may include a raw, unscaled output of the final layer of a neural network before the output is provided to a softmax function. The AI training subsystem 141 may train the teacher AI model 151 until the teacher AI model converges.

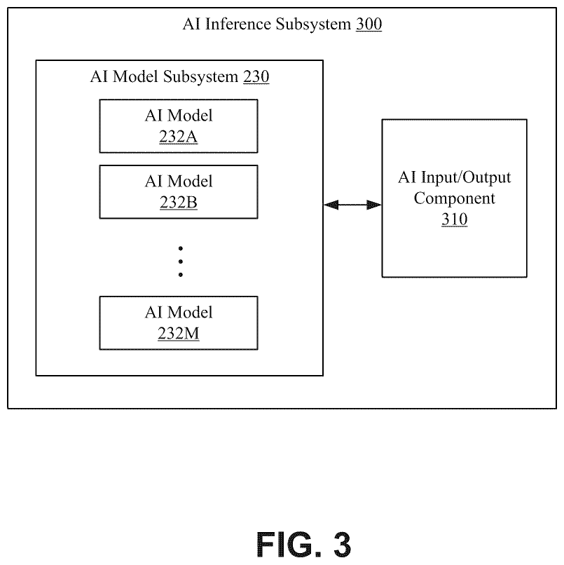

FIG. 3 depicts one implementation of an AI inference subsystem 300. The AI inference subsystem 300 may include the AI model subsystem 230, which may include one or more AI models 151, 152A-Z. The AI inference subsystem 300 may include an AI input/output component 310. The AI input/output component 310 may be configured to feed data as input to an AI model 151, 152A-Z and obtain one or more outputs. In such implementations, the AI input/output component 310 feeds characteristics of media items 122A-M as input to an AI model 151, 152A-Z and obtain one or more outputs.

In some implementations, the AI inference subsystem 300 is part of the server machine 150. In some implementations, the AI inference subsystem 300 is part of the recommendation engine 121. In implementations where the AI inference subsystem 300 is part of the recommendation engine 121, the AI model subsystem 230 may be located on the server machine 150, and the AI input/output component 310 may communicate with the AI model subsystem 230 over the network 108.

In one implementation, in response to a client device 102A-N accessing a media item on the media platform 120, the recommendation engine 121 may use a student AI model 152A-Z to generate a list of recommended media items 122A-M, as discussed herein, and provide at least a portion of the list of recommended media items 122A-M to the client device 102A-N. The client device 102A-N may display, on a UI of the client device 102A-N, one or more UI elements that a user of the client device 102A-N may interact with to access one or more media items 122A-M. The UI elements may be ordered based on scores generated by the student AI model 152A-Z. In some implementations, the recommendation engine 121 may perform the some of the above functionality in response to the client device 102A-N accessing a “Home” portion of the media platform 120 (e.g., a homepage of a website provided by the media platform 120, a landing page of a mobile application of the media platform 120, etc.).

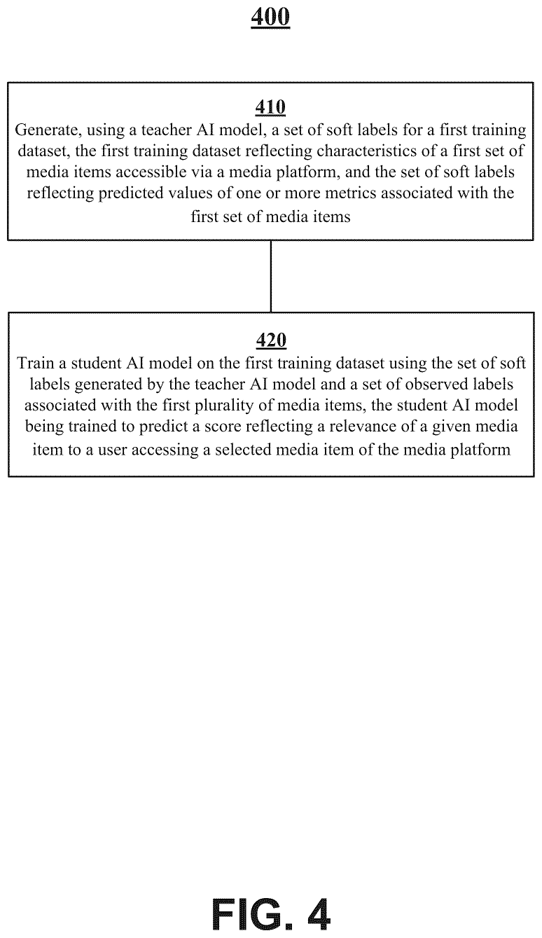

FIG. 4 is a flowchart illustrating one embodiment of a method 400 for generating media item recommendations, in accordance with some implementations of the present disclosure. A processing device, having one or more central processing units (CPU(s)), one or more graphics processing units (GPU(s)), and/or memory devices communicatively coupled to the one or more CPU(s) and/or GPU(s) can perform the method 400 and/or one or more of the method's 400 individual functions, routines, subroutines, or operations. In certain implementations, a single processing thread can perform the method 400. Alternatively, two or more processing threads can perform the method 400, each thread executing one or more individual functions, routines, subroutines, or operations of the method. In an illustrative example, the processing threads implementing the method 400 can be synchronized (e.g., using semaphores, critical sections, and/or other thread synchronization mechanisms). Alternatively, the processing threads implementing the method 400 can be executed asynchronously with respect to each other. Various operations of the method 400 can be performed in a different (e.g., reversed) order compared with the order shown in FIG. 4. Some operations of the method 400 can be performed concurrently with other operations. Some operations can be optional. In some embodiments, the AI training subsystem 141 may perform one or more of the operations.

At block 410, processing logic generates, using a teacher AI model 151, a set of soft labels for a first training dataset. The first training dataset may reflect characteristics of a first set of media items 122A-M accessible via a media platform 120. The set of soft labels reflect predicted values of one or more metrics associated with the first set of media items 122A-M. The teacher AI model 151 may have been previously trained on a training dataset to generate the soft labels. Each item of the first training dataset may include, as the training input, data reflecting the characteristics of a media item 122 of the first set of media items 122A-M and may further include, as the target output, the soft label generated by the teacher AI model 151 in response to the teacher AI model 151 using the training input as input. In one implementation, block 410 may include the AI input/output component 310 of the AI inference subsystem 300 data reflecting the characteristics of a media item 122 (e.g., from the training data generator 131); the AI input/output component 310 providing the data reflecting the characteristics of the media item 122 to the teacher AI model 151; the teacher AI model 151 performing an inference calculation to generate the soft label; the AI training subsystem 141 using the data reflecting the characteristics of a media item 122, the soft label, and the observed label for the media item 122 to generate an item of training data; and including the item of training data in the first training dataset. This process may repeat until, for example, a sufficient number of items have been included in the first training dataset.

At block 420, processing logic trains a student AI model 152A-Z on the first training dataset using the set of soft labels generated by the teacher AI model 151 and the set of observed labels associated with the first set of media items 122A-M. The student AI model 152A-Z is trained to predict a score reflecting a relevance of a given media item 122A-M to a user accessing a selected media item 122A-M of the media platform 120. The user may be acting in a current user context of the media platform 120.

In one implementation, the score may include one or more predicted metrics for the given media item 122A-M. The predicted metrics may include a CTR for the media item 122A-M, an access time of the media item 122A-M, a number of positive feedback items for the media item 122A-M, or other metrics discussed above. In some implementations, the score may include an overall score derived from one or more predicted metrics for the given media item 122A-M.

In some implementations, the user may be acting in a current user context of the media platform 120. The current user context may include a current time of day, a current date, or a current location of the user. The current user context may include the portion of the media platform 120 that the user is accessing. The user may access the portion via the user's client device 102A-N. A first portion of the media platform 120 may include a homepage. The homepage may include a home webpage of the media platform 120 or a splash screen of a mobile application used to access the media platform 120. The homepage may include links one or more media items 122A-N of the media platform 120. A second portion of the media platform 120 may include a media view page. The media view page may include a portion of the media platform 120 where the user accessing a media item 122A-M (watches a video, views an image, listens to audio, etc.). A student AI model 152A-Z may receive context data as part of the AI model's input, and the context data may indicate the current user context.

In one implementation, the method 400 further includes processing logic that pre-trains the teacher AI model 151 on a second training dataset until the teacher AI model 151 achieves a threshold convergence. The second training dataset reflects characteristics of a second set of media items 122A-M accessible via the media platform 120.

In some implementations, training the student AI model 152A-Z on the first training dataset may include multiple iterations, each iteration including: (1) calculating a distillation loss metric based on an output of the student AI model 152A-Z and a distillation weight; (2) updating parameters of the student AI model 152A-Z based on the distillation loss metric; and (3) increasing the distillation weight.

In some implementations, training the student AI model 152A-Z on the first training dataset includes minimizing a joint loss over the soft labels and the observed data. Minimizing the joint loss may include: (1) calculating a soft label loss metric that reflects a difference between an output of a selected layer of the student AI model 152A-Z and the set of soft labels; (2) calculating an observed label loss metric that reflects a difference between the output of the selected layer of the student AI model 152A-Z and the set of observed labels; and (3) updating parameters of the student AI model 152A-Z based on the soft label loss metric and the observed label loss metric to minimize the soft label loss metric and the observed label loss metric.

In one or more implementations, the first set of media items 122A-N may pertain to a time period for which the teacher AI model 151 has not yet been trained. The teacher AI model 151 may still generate soft labels for a training dataset reflecting characteristics of the first set of media items 122A-N. As an example, the first set of media items 122A-N may include media items 122A-M that were uploaded to the media platform 120 three days prior. The teacher AI model 151 may have been trained on training data reflecting characteristics of media items 122A-M that were uploaded to the media platform more than three days prior, but may not yet have been trained on training data reflecting characteristics of media items 122A-M that were uploaded to the media platform three days prior. The AI training subsystem 141 may still cause the teacher AI model 151 to generate a set of soft labels for the first training dataset.

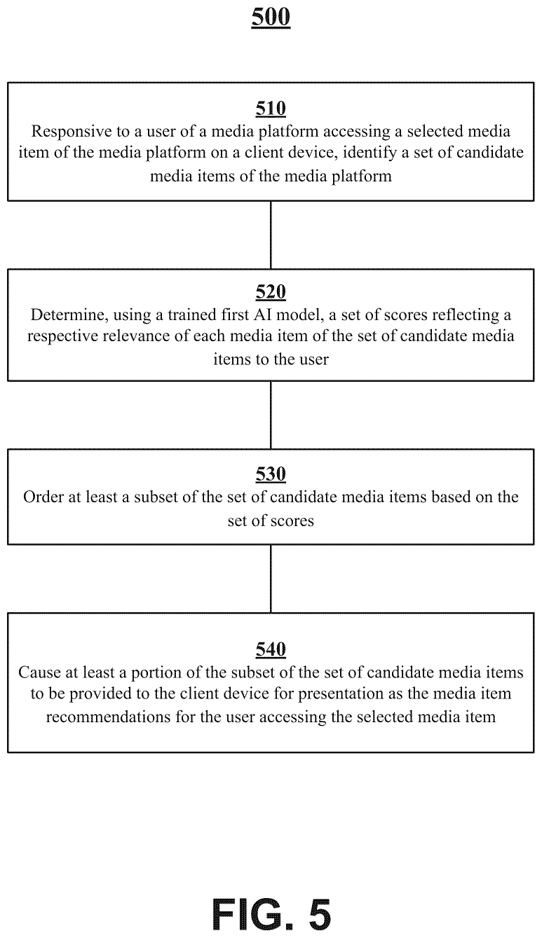

FIG. 5 is a flowchart illustrating one embodiment of a method 500 for generating media item recommendations, in accordance with some implementations of the present disclosure. A processing device, having one or more CPU(s), one or more GPU(s), and/or memory devices communicatively coupled to the one or more CPU(s) and/or GPU(s) can perform the method 500 and/or one or more of the method's 500 individual functions, routines, subroutines, or operations. In certain implementations, a single processing thread can perform the method 500. Alternatively, two or more processing threads can perform the method 500, each thread executing one or more individual functions, routines, subroutines, or operations of the method. In an illustrative example, the processing threads implementing the method 500 can be synchronized (e.g., using semaphores, critical sections, and/or other thread synchronization mechanisms). Alternatively, the processing threads implementing the method 500 can be executed asynchronously with respect to each other. Various operations of the method 500 can be performed in a different (e.g., reversed) order compared with the order shown in FIG. 5. Some operations of the method 500 can be performed concurrently with other operations. Some operations can be optional. In some embodiments, the recommendation engine 121 may perform one or more of the operations.

At block 510, responsive to a user of the media platform 120 accessing a selected media item 122A-M of the media platform 120 on a client device 102A-N, processing logic identifies a set of candidate media items 122A-M of the media platform 120. Identifying the set of candidate media items 122A-M may include the recommendation engine 121 randomly selecting the set of candidate media items 122A-M from among one or more media items 122A-M stored or maintained by the media platform 120.

As an example, the client device 102A-N may include an application for accessing media items 122A-M on the media platform 120. The application may display a UI of the application on a display device of the client device 102A-N. The UI may include one or more UI elements corresponding to the media items 122A-M. For example, where the media items 122A-M include images or video, the UI elements may include thumbnails of the images or videos. Where the media items 122A-M include audio, the UI elements may include thumbnails of visual media associated with the audio (e.g., for music, an album cover of the audio). The user of the client device 102A-N may access a media item 122A-N by interacting with the UI element corresponding to the media item (e.g., clicking on the UI element, tapping the UI element on a touch screen, etc.).

At block 520, processing logic determines, using a trained first AI model, a set of scores reflecting a respective relevance of each media item 122A-M of the set of candidate media items 122A-M to the user. The trained first AI model may be trained on a training dataset that includes (1) a set of characteristics of a set of media items 122A-M accessible via the media platform 120, (2) a set of soft labels produced by a second AI model, the set of soft labels reflecting predicted values of one or more metrics associated with the set of media items 122A-M, and (3) a set of observed labels that reflect observed values of the one or more metrics associated with the set of media items 122A-M. In some implementations, the first AI model may include a student AI model 152A-Z, and the second AI model may include the teacher AI model 151. The teacher AI model 151 may be co-trained with one or more student AI models 152A-Z.

At block 530, processing logic orders at least a subset of the set of candidate media items 122A-M based on the set of scores. For example, where a higher score indicates that the associated media item 122A-M is more relevant to the user than a media item 122A-M with a lower score, the processing logic may order the subset of candidate media items 122A-M from highest to lowest score.

At block 540, processing logic causes at least a portion of the subset of the set of candidate media items 122A-M to be provided to the client device 102A-N for presentation as the media item 122A-M recommendations for the user accessing the selected media item 122A-M. For example, responsive to the user accessing the selected media item 122A-M in block 510, the UI of the client device 102A-N may display a UI element corresponding to the selected media item 122A-M (e.g., where the selected media item 122A-M is a video, the UI element may include a media player that plays back the video). The UI of the client device 102A-N may further display a recommendations section that includes UI elements corresponding to the at least a portion of the subset of the set of candidate media items 122A-M. The UI elements may include thumbnails corresponding to the portion of the subset or other corresponding UI elements that the user can interact with to access a media item 122A-M of the portion of the subset.

In some implementations, the trained first AI model may include a first classification head configured to predict a first score reflecting a relevance of a given media item 122A-M to the user accessing the selected media item 122A-M via the media platform 120. The user may be acting in a current user context of the media platform 120. The first classification head may use direct distillation. The first classification head may include the final layer of the neural network of the first AI model. The first classification head may generate a predicted relevance score for the selected media item 122A-M. Direct distillation may include the first AI model using the same logit to minimize the soft label loss metric and the observed label loss metric discussed above.

In one implementation, the trained first AI model may include a second classification head configured to predict a second score reflecting the relevance of the given media item 122A-M to the user accessing the selected media item 122A-M via the media platform 120. The user may be acting in a current user context of the media platform 120. The second classification head may use auxiliary distillation. Auxiliary distillation may include the first AI model producing a first logit used to minimize the soft label loss metric and a second logit used to minimize the observed label loss metric.

Further aspects, implementations, and details of components of FIG. 1 and the operations of the methods 200 and 300 provided in the appendix attached hereto. Such material in the appendix should not be taken to limit the disclosure but are examples for explanation and understanding only.

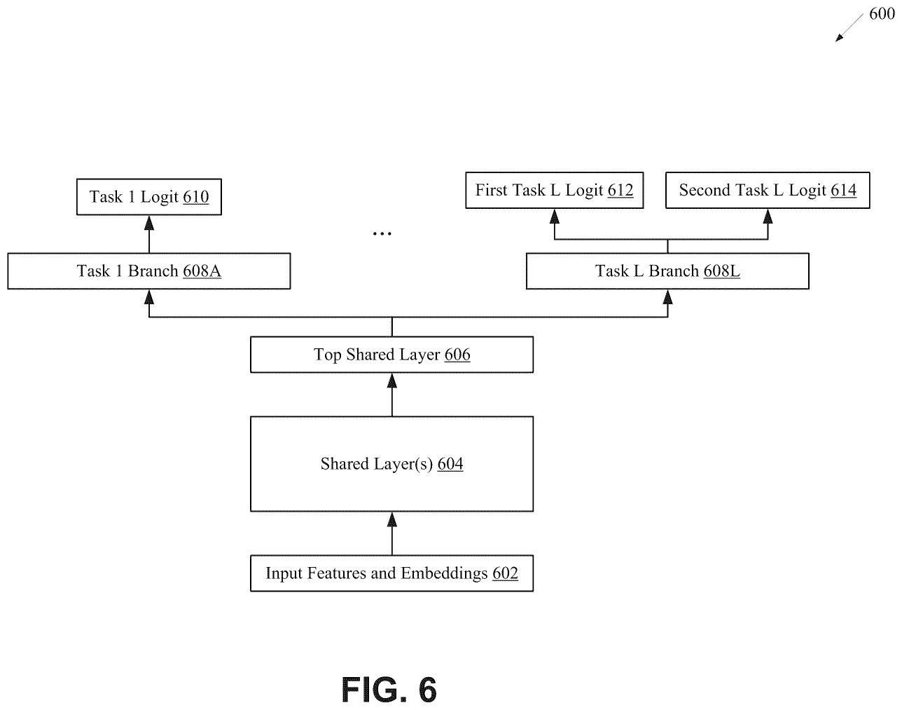

FIG. 6 is a schematic diagram illustrating an example AI model 600, in accordance with implementations of the present disclosure. The AI model 600 may include the teacher AI model 151 or one or more of the student AI models 152A-Z.

In one implementation, input features and embeddings 602 may be provided to the AI model 600. The input features and embeddings 602 may include one or more characteristics of a media item 122A-M (e.g., title, genre, author/creator, subject, duration, etc.). An embedding may include a vector. The embedding may include a numerical representation of data converted to a vector in order for the AI model 600 to perform inference calculations. The input features and embeddings 602 may be provided to one or more shared layers 604 of the AI model 600. The one or more shared layers 604 may include layers of an ANN included in the AI model 600. The one or more shared layers 604 may include an input layer and one or more hidden layers. AS part of an inference calculation of the AI model 600, an activation of one layer of the shared layers 604 may be provide to a subsequent layer.

The AI model 600 may include a top shared layer 606. The top shared layer 606 may be final layer of the ANN shared by subsequent portions of the AI model 600. The AI model 600 may further include one or more branches 608A-L. Each branch 608A-L may include one or more layers of the ANN. The top shared layer 606 may provide its activation to each first layer of each branch 608A-L. Since the layers of one branch 608A-L do not interact with the layers of another branch 608A-L, the layers of the branches 608A-L are not “shared” like the layers of the shared layer(s) 604 and the top shared layer 606. Each branch 608A-L may be associated with a metric of a media item 122A-M (e.g., CTR, access time, number of positive feedback items, etc.). The branch 608A-L may generate a logit 610, 612, 614 used to predict the metric associated with the respective branch 608A-L.

As can be seen in FIG. 6, in some implementations, a branch 608A may generate a singular logit 610 used in predicting the metric associated with the branch 608A. The branch 608A may include the first classification head discussed above, and the branch 608A may use direct distillation. Thus, the AI model 600 may use the logit 610 to minimize the soft label loss metric and the observed label loss metric. As can also be seen in FIG. 6, in some implementations, a branch 608L may generate two logits 612, 614 used in predicting the metric associated with the branch 608L. The branch 608L may include the second classification head discussed above, and the branch 608L may use auxiliary distillation. Thus, the AI model 600 may use the first logit 612 to minimize the soft label loss metric and may use the second logit 614 to minimize the observed label loss metric.

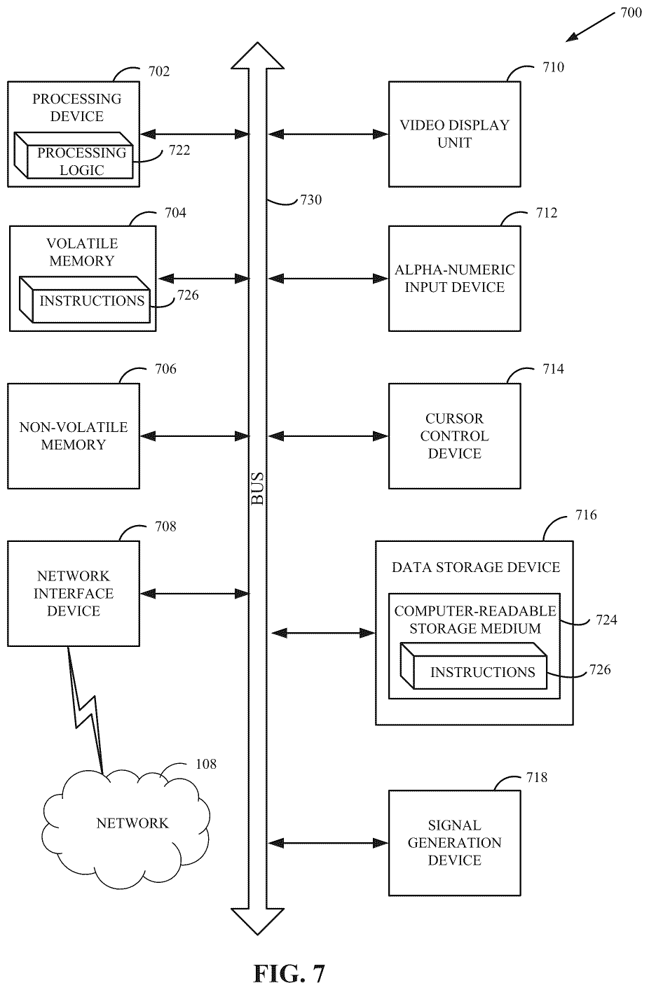

FIG. 7 is a block diagram illustrating an example computer system 700, in accordance with implementations of the present disclosure. The computer system can be a computing device or other device discussed herein. The computer system 700 can be a client device 102A-N, the media platform 120 or a server machine 130, 140, or 150 of FIG. 1. The computer system 700 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a volatile memory 704 (e.g., read-only memory (ROM), flash memory, dynamic random access memory (DRAM) such as synchronous DRAM (SDRAM), double data rate (DDR SDRAM), or DRAM (RDRAM), etc.), a non-volatile memory 706 (e.g., flash memory, static random access memory (SRAM), etc.), and a data storage device 716, which communicate with each other via a bus 730.

The processing device 702 represents one or more general-purpose processing devices such as a microprocessor, CPU, GPU, or the like. More particularly, the processing device 702 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 can also be one or more special-purpose processing devices such as an ASIC, a field programmable gate array (FPGA), a digital signal processor (DSP), network processor, or the like. The processing device 702 is configured to execute instructions 726 (e.g., for performing one or more of the methods 200 or 300) for performing the operations discussed herein.

The computer system 700 can further include a network interface device 708. The network interface device 708 can assist in data communication between computing devices. The computer system 700 also can include a video display unit 710 (e.g., a liquid crystal display (LCD) or a cathode ray tube (CRT)), an input device 712 (e.g., a keyboard, and alphanumeric keyboard, a motion sensing input device, touch screen), a cursor control device 714 (e.g., a mouse), and a signal generation device 718 (e.g., a speaker).

The data storage device 716 can include a non-transitory machine-readable storage medium 724 (also computer-readable storage medium) on which is stored one or more sets of instructions 726. The instructions may embody any one or more of the methodologies or functions described herein. The instructions 726 can also reside, completely or at least partially, within the volatile memory 704 and/or within the processing device 702 during execution thereof by the computer system 700, the volatile memory 704 and the processing device 702 also constituting machine-readable storage media. The instructions 726 can further be transmitted or received over a network 720 via the network interface device 708.

In one implementation, the instructions 726 include instructions for an AI system for media item recommendations. While the computer-readable storage medium 724 (machine-readable storage medium) is shown in an example implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure can be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “displaying”, “moving”, “adjusting”, “replacing”, “determining”, “playing”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

For simplicity of explanation, the methods 200 and 300 are depicted and described herein as a series of acts. However, acts in accordance with this disclosure can occur in various orders and/or concurrently, and with other acts not presented and described herein. Furthermore, not all illustrated acts can be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Certain implementations of the present disclosure also relate to an apparatus for performing the operations herein. This apparatus can be constructed for the intended purposes, or it can comprise a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one implementation,” “an implementation,” “some implementations,” “one embodiment,” “an embodiment,” or “some embodiments” mean that a particular feature, structure, or characteristic described in connection with the implementation or embodiment is included in at least one implementation or embodiment. Thus, the appearances of the phrase “in one implementation” or “in an implementation” or other similar terms in various places throughout this specification are not necessarily all referring to the same implementation. In addition, the term “or” is intended to mean an inclusive “or” rather than an exclusive “or.” Moreover, the word “example” or a similar term are used herein to mean serving as an example, instance, or illustration. Any aspect or design described herein as an “example” is not necessarily to be construed as preferred or advantageous over other aspects or designs. Rather, use of the word “example” or a similar term is intended to present concepts in a concrete fashion.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method, comprising:
generating, using a teacher artificial intelligence (AI) model, a set of soft labels for a first training dataset, wherein the first training dataset reflects characteristics of a first plurality of media items accessible via a media platform, wherein the set of soft labels reflect predicted values of one or more metrics associated with the first plurality of media items; and
training a student AI model on the first training dataset using the set of soft labels generated by the teacher AI model and a set of observed labels associated with the first plurality of media items, wherein the student AI model is trained to predict a score reflecting a relevance of a given media item to a user acting in a current user context of the media platform.

2. The method of claim 1, wherein the teacher AI model and the student AI model share a common architecture comprising a plurality of neural network layers, and wherein a size of a layer of the teacher AI model is a multiple of a size of a corresponding layer of the student AI model.

3. The method of claim 1, wherein the teacher AI model and the student AI model share a common architecture comprising a plurality of neural network layers, and wherein a number of shared layers comprised by the teacher AI model is a multiple of a number of shared layers comprised by the student AI model.

4. The method of claim 1, further comprising pre-training the teacher AI model on a second training dataset until the teacher AI model achieves a threshold convergence, wherein the second training dataset reflects characteristics of a second plurality of media items accessible via the media platform.

5. The method of claim 1, wherein training the student AI model on the first training dataset comprises a plurality of iterations, each iteration comprising:
calculating a distillation loss metric based on an output of the student AI model and a distillation weight;
updating parameters of the student AI model based on the distillation loss metric; and
increasing the distillation weight.

6. The method of claim 1, wherein training the student AI model on the first training dataset comprises:
calculating a soft label loss metric that reflects a difference between an output of a selected layer of the student AI model and the set of soft labels;
calculating an observed label loss metric that reflects a difference between the output of the selected layer of the student AI model and the set of observed labels; and
updating parameters of the student AI model based on the soft label loss metric and the observed label loss metric.

7. The method of claim 1, wherein two or more student AI models are co-trained with the teacher AI model to facilitate a selection of a best performing student AI model for inference.

8. The method of claim 1, wherein the one or more metrics associated with the first plurality of media items comprise one or more engagement metrics and one or more satisfaction metrics.

9. The method of claim 8, wherein the one or more engagement metrics and the one or more satisfaction metrics comprise two or more of:
a click-through rate of a media item of the first plurality of media items;
an access time of a media item of the first plurality of media items;
a number of positive feedback items received for a media item of the first plurality of media items;
a number of negative feedback items received for a media item of the first plurality of media items;
a dismissal rate of a media item of the first plurality of media items; or
a number of sharing actions with respect to a media item of the first plurality of media items.

10. The method of claim 1, wherein the teacher AI model and the student AI model form part of a knowledge distillation framework.

11. A method for generating media item recommendations for a user, comprising:
responsive to a user of a media platform accessing a selected media item of the media platform on a client device, identifying a set of candidate media items of the media platform;
determining, using a trained first artificial intelligence (AI) model, a plurality of scores reflecting a respective relevance of each media item of the set of candidate media items to the user, wherein the trained first AI model is trained on a training dataset comprising:
a plurality of characteristics of a plurality of media items accessible via the media platform,
a set of soft labels produced by a second AI model, wherein the set of soft labels reflect predicted values of one or more metrics associated with the plurality of media items, and
a set of observed labels, wherein the set of observed labels reflect observed values of the one or more metrics associated with the plurality of media items;
ordering at least a subset of the set of candidate media items based on the plurality of scores; and
causing at least a portion of the subset of the set of candidate media items to be provided to the client device for presentation as the media item recommendations for the user accessing the selected media item.

12. The method of claim 11, wherein the second AI model is a teacher AI model that is co-trained with one or more student AI models comprising the trained first AI model.

13. The method of claim 11, wherein the trained first AI model comprises at least one of:
a first classification head configured to predict a first score reflecting a relevance of a given media item to the user acting in a current user context of the media platform, wherein the first classification head uses direct distillation; or
a second classification head configured to predict a second score reflecting the relevance of the given media item to the user acting in a current user context of the media platform, wherein the first classification head uses auxiliary distillation.

14. The method of claim 11, wherein the one or more metrics associated with the plurality of media items comprise one or more engagement metrics and one or more satisfaction metrics.

15. The method of claim 14, wherein the one or more engagement metrics and one or more satisfaction metrics comprise two or more of:
a click-through rate of a media item of the plurality of media items;
an access time of a media item of the plurality of media items;
a number of positive feedback items received by a media item of the plurality of media items;
a number of negative feedback items received by a media item of the plurality of media items;
a dismissal rate of a media item of the plurality of media items; or
a number of sharing actions with respect to a media item of the plurality of media items.

16. A system, comprising:
a processing device; and
a memory, coupled with the processing device, comprising instructions that when executed by the processing device, perform operations comprising:
responsive to a user of a media platform accessing a selected media item of the media platform on a client device, identifying a set of candidate media items of the media platform;
determining, using a trained first artificial intelligence (AI) model, a plurality of scores reflecting a respective relevance of each media item of the set of candidate media items to the user, wherein the trained first AI model is trained on a training dataset comprising:
a plurality of characteristics of a plurality of media items accessible via the media platform,
a set of soft labels produced by a second AI model, wherein the set of soft labels reflect predicted values of one or more metrics associated with the plurality of media items, and
a set of observed labels, wherein the set of observed labels reflect observed values of the one or more metrics associated with the plurality of media items;
ordering at least a subset of the set of candidate media items based on the plurality of scores; and
causing at least a portion of the subset of the set of candidate media items to be provided to the client device for presentation as media item recommendations for the user accessing the selected media item.

17. The system of claim 16, wherein the second AI model is a teacher AI model that is co-trained with one or more student AI models comprising the trained first AI model.

18. The system of claim 16, wherein the trained first AI model comprises at least one of:
a first classification head configured to predict a first score reflecting a relevance of a given media item to the user acting in a current user context of the media platform, wherein the first classification head uses direct distillation; or
a second classification head configured to predict a second score reflecting the relevance of the given media item to the user acting in a current user context of the media platform, wherein the first classification head uses auxiliary distillation.

19. The system of claim 16, wherein the one or more metrics associated with the plurality of media items comprise one or more engagement metrics and one or more satisfaction metrics.

20. The system of claim 19, wherein the one or more engagement metrics and one or more satisfaction metrics comprise two or more of:
a click-through rate of a media item of the plurality of media items;
an access time of a media item of the plurality of media items;
a number of positive feedback items received by a media item of the plurality of media items;
a number of negative feedback items received by a media item of the plurality of media items;
a dismissal rate of a media item of the plurality of media items; or
a number of sharing actions with respect to a media item of the plurality of media items.
